(19) United States
(12) Patent Application Publication
(10) Pub. No.: US 2021/0307350 A1
(43) Pub. Date: Oct. 7, 2021

(54) TEA SOLID COMPOSITION AND PROCESS OF MAKING THE SAME

(71) Applicant: HUMBLE TEA, INC., LOS ANGELES, CA (US)

(72) Inventor: Sashee Bala Chandran, Los Gatos, CA (US)

(21) Appl. No.: 17/347,954

(22) Filed: Jun. 15, 2021

Related U.S. Application Data
(63) Continuation-in-part of application No. 14/943,979, filed on Nov. 17, 2015, now Pat. No. 11,033,041.
(60) Provisional application No. 62/080,899, filed on Nov. 17, 2014.

(51) Int. Cl. A23F 3/14; A23P 30/10

(52) U.S. Cl. CPC A23F 3/14; A23P 30/10

(57) ABSTRACT

A tea solid composition comprising a mixture of finely ground tea, a binding agent and water, wherein the mixture forms a tea solid composition in response to heating and subsequent cooling in a mold. The tea solid composition may further include at least one ingredient selected from the group consisting of a sweetener, a ground spice, a flavor extract, a powdered milk product, a color additive and a thickener.

### FIELD OF THE INVENTION

The present invention relates generally to a consumable tea solid composition, and more specifically to a prepared individual serving of a tea composition that is convenient to use.

### CROSS REFERENCE TO RELATED APPLICATIONS

This application is a continuation in part application of U.S. patent application Ser. No. 14/943,979 filed Nov. 17, 2015, and further claims the benefit of an earlier filing date from U.S. Patent Application Ser. No. 62/080,899, filed Nov. 17, 2014, the contents of which are incorporated by reference herein in their entirety.

### BACKGROUND OF THE INVENTION

Loose-leaf tea, tea bags and instant tea powders are known in the art. Using loose-leaf tea and tea bags requires the consumer to dispose of the used tea leaves and/or the tea bag after the tea has been brewed. While instant tea powders do not require disposal of the used tea leaves or tea bags, instant tea powders are produced by infusion, extraction and reduction processes, in which a large percentage of the nutrients of the tea, including vitamins, minerals, antioxidants and catechins are lost during the process of making the instant tea powder.

In addition, in the standard process for brewing a cup of tea, the loose-leaf tea and tea bags are separate entities from the sugar and/or milk which are typically added to a tea-based beverage, prior to consumption. Accordingly, a consumer desiring a cup of tea with sugar and milk requires that the user obtain each of these items separately, prior to making the beverage. As such, the standard process for making a cup of tea is time consuming and inconvenient.

According, what is needed in the art is a product that provides a convenient and efficient way of making a cup of tea, while still retaining the desired nutritive value of the resulting brewed tea.

### SUMMARY

The present invention provides a product that will aid in the creation of a tea beverage. Specifically, the invention relates to a tea solid composition that can be placed into hot water (above 100° F.), stirred and then immediately consumed. In particular embodiments, the tea solid composition may include a sweetener, dry milk and additional spices and flavorings.

In one embodiment, a method of producing the tea solid composition in accordance with the present invention includes, forming a mixture comprising finely ground tea, a binding agent and water. After the mixture has been formed, the method continues by placing the mixture into a mold, heating the mixture in the mold and allowing the mixture to cool in the mold to form the tea solid composition.

In an additional embodiment, a tea solid composition is provided comprising a mixture of finely ground tea, a binding agent and water, wherein the mixture forms a tea solid composition in response to heating and subsequent cooling in a mold. In a particular embodiment, the mold is dimensioned to provide an individual serving of tea when the tea solid composition is placed into hot or cold water. When placed into hot water, the tea solid composition dissolves and can be immediately consumed. In an alternative embodiment, the tea solid composition can also be placed in cold water (below room temperature) for an extended period of time, such as in a cold brewing process, prior to consumption.

Accordingly, the present invention provides a tea solid composition that provides a convenient and efficient way of making a cup of tea, while still retaining the desired nutritive value of the brewed tea.

### BRIEF DESCRIPTION OF THE DRAWINGS

The accompanying drawings are included to provide a further understanding of the invention and are incorporated in and constitute a part of this specification. The drawings illustrate embodiments of the invention, and together with the description, serve to explain the principles of the invention.

FIG. 1 is a flow diagram illustrating a process for producing the tea solid composition, in accordance with an embodiment of the present invention.

FIG. 2A is a first table illustrating possible embodiments of the tea solid composition of the present invention.

FIG. 2B is a second table illustrating possible embodiments of the tea solid composition of the present invention.

FIG. 3A is a diagrammatic view of a tea solid composition in the form of a three-dimension star, in accordance with an embodiment of the present invention.

FIG. 3B is a diagrammatic view of a tea solid composition in the form of a three-dimensional diamond, in accordance with an embodiment of the present invention.

FIG. 3C is a diagrammatic view of a tea solid composition in the form of a cube, in accordance with an embodiment of the present invention.

FIG. 3D is a diagrammatic view of a tea solid composition in the form of a three-dimensional heart, in accordance with an embodiment of the present invention.

FIG. 3E is a diagrammatic view of a tea solid composition in the form of a sphere, in accordance with an embodiment of the present invention.

### DETAILED DESCRIPTION

The present invention provides a product that will aid in the creation of a tea beverage. Specifically, the invention relates to a tea solid composition that can be placed into hot water (above 100° F.), stirred and then immediately consumed. In particular embodiments, the tea solid composition may include a sweetener, dry milk and additional spices and flavorings.

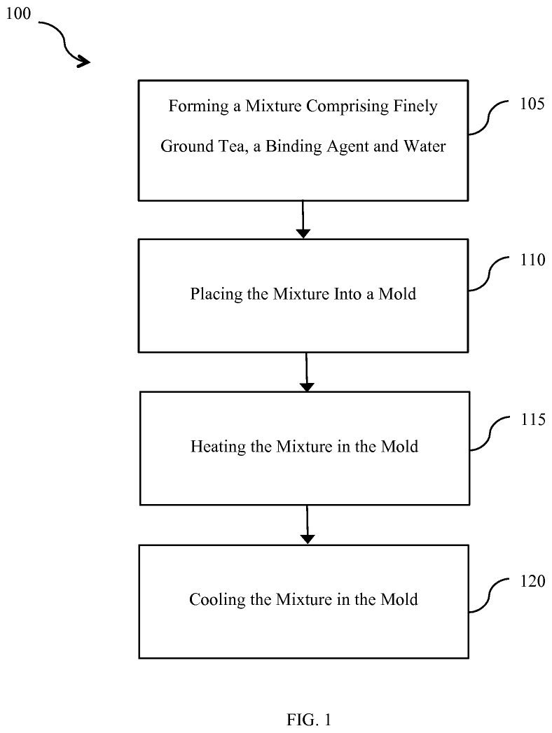

With reference to FIG. 1, in one embodiment a method of manufacturing a tea solid composition 100 in accordance with the present invention includes, forming a mixture comprising finely ground tea, a binding agent and water 105. The method further includes, placing the mixture into a mold 110, heating the mixture in the mold 115 and subsequently cooling the mixture in the mold 120, thereby forming the tea solid composition. The tea solid composition is so called because the tea leaves are of a size that renders them insoluble in water (hot or cold). The tea leaves undergo expansion in the presence of water and are visible to the naked eye before and after immersion in water.

The finely ground tea of the tea solid composition may be prepared by various methods known in the art for grinding tea leaves, such as using a granite stone grinding mill and pressure pulverization. The tea powder of the present invention is not extracted tea, but rather the tea powder in a finely ground tea in which the microscopic particles retain all of the essential characteristics of the original tea leaves. The present invention involves the grinding of tea leaves or components of an herbal tea, using known methods, until a desired particle size has been achieved. In a specific embodiment, the tea is ground using a spice grinder to obtain a tea powder having a particle size between approximately 0.1 mm and 0.2 mm. The tea leaves expand upon being solubilized by the water. In other words, the tea leaves are larger in size after being solubilized by water and are visible to the naked eye. In an embodiment, more than 50%, preferably more than 60%, preferably more than 70%, and preferably more than 80% by volume of the tea is visible to the naked eye after immersion in water. One immersed in water, the tea leaves are unconstrained, i.e., they are not constrained in a semi-permeable bag or in a filter. The tea leaves can be dispersed in a liquid upon agitation and provide flavor to the liquid in which they are immersed. The particle size of the finely ground tea is such that when the tea solid composition comprising the ground tea powder is placed into a cup of water, the ground tea powder does not completely dissolve and sediment remains from the finely ground tea. The sediment can be dispersed in the liquid (e.g., water or milk) upon agitation and will then resettle on the bottom of the cup.

As used herein, the term “tea” relates to any product that may comprise cured leaves of the Cameilla Sinesis plant, despite oxidation levels. The definition of “tea” used herein encompasses all six different types of tea, including white, yellow, green, oolong, black and post-fermented tea. The definition of “tea” also includes the combination of Cameilla Sinesis plus any other additives to the tea including spices, plants, dried fruits, seeds, plant or fruit extracts, whether combined as whole, partial or pulverized. “Tea” also refers to infusion of fruit or herbs made without the tea plant, such as tisane or herbal infusions, but bearing an implied contrast with “tea” as it is construed here. “Tea” may also include herbal or spice varieties, including, but not limited to spearmint, peppermint leaves, ground ginger and ground orange powder. In general, the term “tea” refers to pulverized ingredients (with or without a Camellia Sinesis base), which results in a powder form of tea.

The binding agent that is mixed with the powdered tea is selected such that upon heating and subsequent cooling of the mixture, the powdered tea will be fixed into a solid form. The binding agent may be a solid sweetener, such as sugar, a liquid sweetener, such as honey, or a thickener, such as rice flour, flavorants such as spices, dried and/or grated fruit skins, dried pulverized fruit and vegetables, or the like, or a combination thereof. All of the binding agents are in powder form prior to mixing with the tea.

In an embodiment, the binding agent remains in powdered form in the tea solid composition. In other words, the binding agent and the tea along with other additives (sweetners) are in powdered form prior to the immersion in water. In another embodiment, the binding agent may be compacted along with the tea to form a tablet that contains compacted binding agent and tea. Other additives such as sweeteners, and the like, may be added to the tablet.

As used herein, the term “sugar” includes any edible product comprises one or more saccharose groups. As such, the term “sugar” includes all monosaccharide or simple sugars, such as glucose, dextrose, fructose and laevulose, the disaccharides, such as sucrose, also known as table sugar, lactose, xylose and maltose and polysaccharides derived from tragacanth. As certain sugars are optically active, such as fructose, the term “sugar” as used herein includes all of the optical isomers and mixtures of such isomers. As user herein, the term “sugar” also includes solid compositions comprising nonnutritive sweeteners, such as those materials having a similar or greater sweetness intensity than table sugar, but with a substantially lower caloric value.

Suitable sugars include monosaccharides, including glucose, isoglucose, fructose, dextrose, fructose, galactose, allulose, or a combination thereof. Compound sugars, also called disaccharides or double sugars, are molecules composed of two monosaccharides joined by a glycosidic bond. Suitable disaccharides include sucrose, lactose, maltose, or a combination thereof. Longer chains of monosaccharides called oligosaccharides or polysaccharides are also included herewith as sugars. Examples of polysaccharides include maltodextrin, cyclodextrin, fructooligosaccharide, maltooligosaccharide, isomaltooligosaccharide, galactooligosaccharide, soybean-oligosaccharide, or the like, or a combination thereof. Combinations of monosaccharides, disaccharides and/or polysaccharides may be used as sweeteners.

In the present invention, useful sugar based components can take a variety of physical forms, which can be used individually or in any combination as a binding agent for the tea powder mixture. For example, useful sucrose table sugars include granulated table sugar, which has a particle size of from about 0.1 mm to about 1.2 mm and a density of from about 0.8 g/mL to about 0.95 g/mL and fine or powdered sugar, which has a particle size of from about 0.1 mm to about 0.8 mm and an associated lower density than granulated sugar. As long as it is a solid, the sugar can be substantially purse, such as a white table sugar and white powdered sugar, incompletely refined, such that some impurities remain after processing, such as brown table sugar, or raw, such as cane sugar. Other useful forms of sugar include turbinado, pre-flavored or pre-colored sugars, such as are commercially available and other novelty sugars, including rock candy.

The term “sugar” as used herein also encompasses any and all liquid sweeteners. Liquid sweeteners include any solution with a liquid component, at a room temperature setting, that is comprises of monosaccharaides fructose and glucose. This definition includes all forms of honey, a sweet food made by bees using nectar from flowers. It also includes all forms of agave nectar, a sweetener commercially produced from several species of agave. Also included Stevia, coconut sugar and date sugar. This definition also include all forms of syrup, including forms made from xylem sap of sugar maple, red maple or black maple trees. In addition, the term, “liquid sweetener” comprises any parts mixture of sugar and water.

As used herein, the term “thickener” relates to any product that increases the viscosity of a solution or liquid/solid mixture, without substantially modifying its other properties. The definition of “thickener” used herein may include, but is not intended to be limited to, oat fiber, cellulose, rice flour, sugar cane or maltodextrin. In an embodiment, the thickener may be a gum. Suitable gums include guar gum, xanthan gum, Arabic gum, agar, carrageenan, Konjac, tara gum, gellan gum, locust bean gum, or the like, or a combination thereof.

In addition to the powdered tea, binding agent and water, additional ingredients may be added to the mixture prior to placing the mixture into the mold. The additional ingredients may include, at least one sweetener, at least one ground spice, at least one flavor extract, at least one powdered milk product and at least one color additive.

A used herein, the term “powdered milk” or “dried milk” refers to a manufactured dairy product made by evaporating milk to dryness. Because milk powder has a far longer shelf life than liquid milk and does not need to be refrigerated, due to its low moisture content, one purpose of drying milk is to preserve it. Powdered milk and dairy products include dry whole milk, nonfat dry milk, dry buttermilk, dry whey products and dry dairy blends. As used herein, the term “powdered milk product” also encompasses other variations of powdered/dried milk, including coconut milk powder. Additionally, the term used herein also includes lactose-free powdered/dried milk alternatives.

As used herein, the term “color additive” refers to any dye, pigment or substance that imparts color when it is added to food or drink. It can appear in forms consisting of liquids, powders, gels and pastes. Color additives may refer to Certified Colors that are approved by the United States FDA in subpart A of the Code of Federal Regulations—Title 21, Part 73. These certified colors are synthetically produced and are used widely because they impart intense, uniform color, are less expensive and blend more easily to create a variety of hues. There are nine certified color additives approved for use in the United States. Artificial coloring is also included in the term “color additives”. In the United States, seven colorings are permitted in food, as of 2007. These artificial colorings include, Blue No. 1, Blue No. 2, Green No. 3, Red No. 40, Red No. 3, Yellow No. 5 and Yellow No. 6. The term “color additive” may also refer to colors that are exempt from certification, including pigments that are derived from natural sources, such as vegetables, minerals or animals. The source of the pigments may include, but is not limited to, caramel coloring (E150), made from caramelized sugar, annatto (E160b), a reddish-orange dye made from the seed of the achiote, chlorophyllin (E140), a green dye made from chlorella algae, cochineal (E120), a red dye derived from the cochineal insect, Dactylopius coccus, betanin (E162) extracted from beets, turmeric (curcuminoids, E100), saffron (carotenoids, E160a), paprika (E160c), lycopene (E160d), elderberry juice, pandan (Pandanus amaryllifolius), a green food coloring, and butterfly pea (Clitoria ternatea), a blue food dye.

As used herein, the term “flavor extract” includes any substance made by extracting a part of a raw material, often by using a solvent, such as ethanol or water. Extracts may be sold as tinctures or in powder form. The aromatic principles of many spices, nuts, herbs, fruits, etc., and some flowers, are marketed as extracts, among the best known of true extracts being almond, cinnamon, cloves, ginger, lemon, nutmeg, orange, peppermint, pistachio, rose, spearmint, vanilla, violet and wintergreen. The definition of “flavor extract” includes the extraction of flavor (natural essences) through any of the methods including, expression, absorption, maceration and distillation. Expression is performed when the oil is very plentiful and easily obtained, as in a lemon peel. Absorption is generally accomplished by steeping in alcohol, as vanilla beans. Maceration is used to create smaller bits of the whole, as in making peppermint extract. Distillation is used along with maceration, but in many cases, distillation requires expert chemical knowledge and the construction of costly stills. Moreover, the definition of “flavor extracts” also includes any substance (essence) chemically created. Concentrated fruit flavors, such as banana, cherry, currant, peach, pineapple, raspberry and strawberry are produced by combinations of various esters together with special oils. The desired colors are generally obtained by the use of dyes. Among the esters most generally employed are ethyl acetate and ethyl butyrate.

Flavorings employed in the tea solid composition include cappuccino, amaretto, baileys, vodka, whisky, pistachio, mocha, hazelnut, hazelnut cream, almond, mint, vanilla, sweetened condensed milk, cinnamon, thyme, lemon, orange, passion fruit, blackberry, banana, pineapple, kiwi, grape, peach, strawberry, cherry, mandarin, guava, pear, apple, papaya, mango, tamarind, cardamom, chamomile, lemon grass, sweet marjoram, cidron, cilantro, orange peel extract, lime peel extract, lemon peel extract, grapefruit extract, ginger root (powder), spearmint leaves, spearmint extract, vanilla extract, cardamon powder, cinnamon powder, ginger powder, red rose buds, macha green powder, blue berry powder, acai powder, coconut palm sugar, turmeric powder, cocoa powder, raspberry leaf, hibiscus, ashwagandha, moringa, nettle leaf, organic lemon extract, organic orange peel, organic orange flavor, organic ginger, organic spearmint, organic bamboo extract, bamboo fiber, or the like, or a combination thereof. Further, the flavorings may be in the form of a powder or an extract. The extract is generally a liquid.

The tea solid composition may provide certain health benefits. For example, a composition that encourages menstrual flow includes maca, cinnamon, ginger, cardamom in addition to the tea leaves. In another example, a tea solid composition that enhances fertility and restores hormonal balance includes raspberry leaf, hibiscus, orange peel and ginger in addition to tea leaves. In yet another example, a tea solid composition that facilitates lactation includes ashwagandha, turmeric, moringa, nettle leaf, cinnamon in addition to tea leaves.

An example of tea solid compositions that include a) Rose Earl Grey tea ingredients that include organic Earl Grey tea, organic rose buds and petals, organic bamboo extract or b) matcha green tea having organic Matcha Green tea and organic bamboo extract.

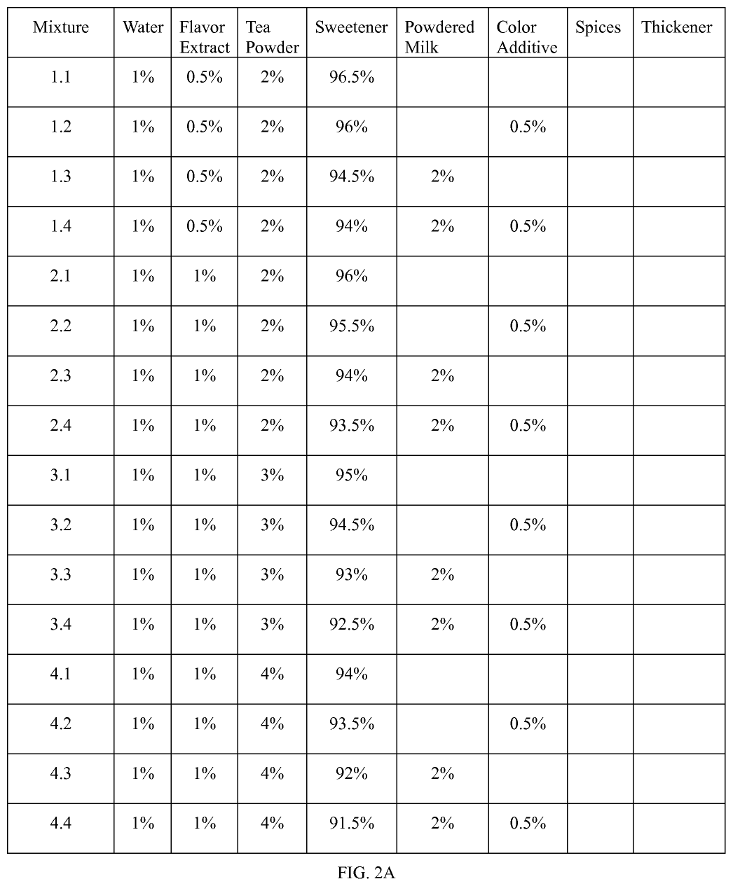

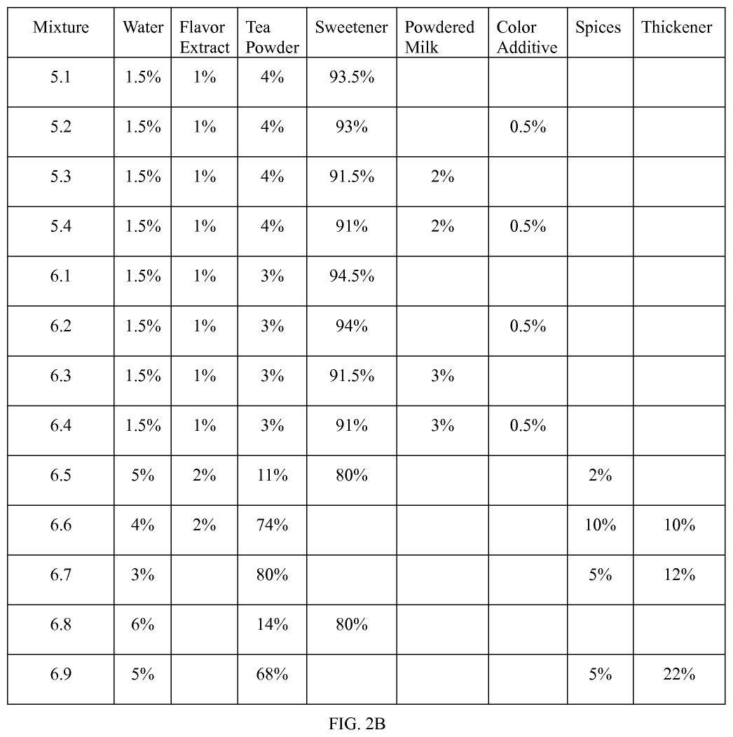

As shown with reference to FIG. 2A and FIG. 2B, various powdered tea mixtures are considered within the scope of the present invention. The tables shown in FIG. 2A and FIG. 2B illustrate various tea solid compositions in accordance with the present invention may include various percentages of powdered tea, water and a binding agent, in the form of a sweetener or a thickener, in addition to flavor extracts, powdered milk spices and color additives. For example, as shown in the top row of the table in FIG. 2A, the mixture forming the tea solid composition of the present invention may include 1% water, 0.5% flavor extract, 2% tea powder and 96.5% sugar. In an additional embodiment, as shown in the bottom row of the table in FIG. 2B, the mixture forming the tea solid composition of the present invention may include 5% water, 68% tea powder, 5% spices and 22% thickener.

After the mixture comprising the finely ground tea, the binding agent and the water has been prepared, the method of the present invention continues by placing the mixture into a desired mold 110. The shape of the mold determines the size and shape of the tea solid composition. The mold may be shaped in various three-dimensional geometric configurations, including, but not limited to, heart, sphere, cube, animal shape, star, diamond, triangular. The mold may also be provided in various dimensions to provide different sizes of the tea solid composition. In general, the shape and weight of the tea solid composition is approximately between 6 grams and 6 grams, making the tea solid composition very portable. In one embodiment the mold is sized to provide an individual serving of tea when the tea solid composition is place into hot or cold water.

After the mixture has been placed in the desired mold 110, the method continues by heating the mixture in the mold further comprises heating the mixture in the mold 115. In one embodiment, the mixture and the mold are heated in an oven at a temperature of between about 150° F. and 180° F. for a duration of approximately 1 hr. to 1.5 hrs. In a specific embodiment, the mixture and the mold are heated in an oven at a temperature of 175° F. for a duration of 1 hr. to 1.5 hrs. During the heating process, the water and the any additional liquid from other ingredients in the tea powder mixture substantially evaporate from the mixture.

Following the heating of the mixture within the mold 115, the mold is removed from the oven and allowed to cool at approximately ambient temperature for a duration of about 1 hr. to 2 hrs. As the heated tea powder mixture cools, the binding agent solidifies and binds the powdered tea into the desired shape defined by the mold, forming the tea solid composition of the present invention.

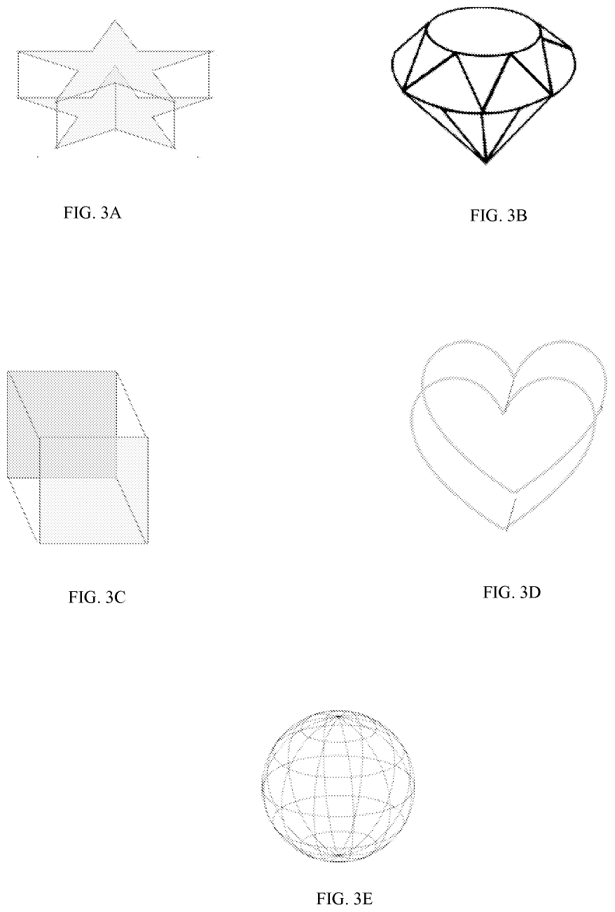

After the powdered tea mixture has cooled in the molds, the resulting tea solid composition can be easily handled while retaining its desired shape. As shown with reference to FIG. 3A-FIG. 3E, the tea solid composition of the present invention may take on various solid shapes. FIG. 3A is a diagrammatic view of a tea solid composition in the form of a three-dimension star, in accordance with an embodiment of the present invention. FIG. 3B is a diagrammatic view of a tea solid composition in the form of a three-dimensional diamond, in accordance with an embodiment of the present invention. FIG. 3C is a diagrammatic view of a tea solid composition in the form of a cube, in accordance with an embodiment of the present invention. FIG. 3D is a diagrammatic view of a tea solid composition in the form of a three-dimensional heart, in accordance with an embodiment of the present invention. FIG. 3E is a diagrammatic view of a tea solid composition in the form of a sphere, in accordance with an embodiment of the present invention. As illustrated, in some embodiments, one dimension of the tea solid composition may be between 0.25 inches to 4 inches, preferably 0.5 inches to 2 inches.

The tea solid composition of the present invention includes a mixture of finely ground tea, a binding agent and water, wherein the mixture forms a tea solid composition in response to heating and subsequent cooling in a mold. The tea solid composition may further include at least one ingredient selected from the group consisting of a sweetener, a ground spice, a flavor extract, a powdered milk product, a color additive and a thickener. The tea solid composition may be in the form of a compacted pellet after heating and cooling in the mold.

In another embodiment, the tea solid composition comprises a mixture of finely ground tea and a binding agent in the form of a compacted pellet. In this embodiment, the finely ground tea is mixed with the finely grounded binding agent and the mixture is then compacted in a mold under pressure. Heat may also optionally be used during the compaction. No water or liquid is used during this compaction.

In another embodiment, the tea solid composition is in powder form that includes a mixture of finely ground tea and a binding agent that is also in powder form. The tea solid composition in powder form flows upon being subjected to a force field (e.g., a gravitational field).

The present invention provides a product that will aid in the creation of a tea beverage. Specifically, the invention relates to a tea solid composition that can be placed into hot water (above 100° F.), stirred and then immediately consumed. In particular embodiments, the tea solid composition may include a sweetener, dry milk and additional spices and flavorings.

As such, the present invention provides a tea solid composition that greatly reduces the time and equipment involved in preparing a tea-based beverage. By combining the tea, a sweetener and milk into one solid compound, the time necessary to prepare a tea-based beverage is minimized and the convenience associated with enjoying a cup of tea in increased.

Although the invention has been described with reference to particular embodiments thereof, it will be apparent to one of ordinary skill in the art that modifications to the described embodiment may be made without departing from the spirit of the invention. Accordingly, the scope of the invention will be defined by the attached claims not by the above detailed description.

What is claimed is:

1. A tea solid composition, comprising;
a mixture of finely ground tea; and
a binding agent; where the binding agent is in the form of a powder; where the finely ground tea does not dissolve when the tea solid composition is placed in a cup of water.

2. The tea solid composition of claim 1, wherein the finely ground tea comprises a ground tea particle size of between approximately 0.1 mm and 0.2 mm.

3. The tea solid composition of claim 1, wherein the finely ground tea is selected from white, yellow, green, oolong, black, post-fermented, tisane and herbal tea powder.

4. The tea solid composition of claim 1, wherein the binding agent is selected from the group consisting of a solid sweetener, a liquid sweetener and a thickener.

5. The tea solid composition of claim 1, further comprising at least one ingredient selected from the group consisting of a sweetener, a ground spice, a flavor extract, a powdered milk product, a color additive and a thickener.

6. The tea solid composition of claim 1, wherein the mold is an individual serving size mold.

7. The tea solid composition of claim 1, wherein the tea powder is not from extracted tea.

8. The tea solid composition of claim 1, where the binding agent is selected from the group consisting of a solid sweetener, a liquid sweetener and a thickener.

9. The tea solid composition of claim 1, where one dimension of the tea solid composition is 0.25 inch to 4 inches.

10. The tea solid composition of claim 9, where one dimension of the tea solid composition is 0.5 to 2 inches.

11. The tea solid composition of claim 1, where the mixture forms a pellet in response to heating and subsequent cooling in a mold.

12. The tea solid composition of claim 11, where the mixture further comprises water prior to being heated and cooled in the mold.

13. The tea solid composition of claim 1, where the finely ground tea is unconstrained after the tea solid composition is mixed with water in a cup.

14. The tea solid composition of claim 13, where the water in the cup is heated.

15. The tea solid composition of claim 1, where the mixture is in the form of a powder.
